(19) United States
(12) Patent Application Publication
(10) Pub. No.: US 2004/0096645 A1
(43) Pub. Date: May 20, 2004

(54) Floor structures

(76) Inventors: Leonard James Hancy, Auckland (NZ); Adrian Francis Bennett, Auckland (NZ); Mark Rodney Bassett, Upper Hutt (NZ); Malcolm John Cunningham, Wellington (NZ); Christopher Dennis Kane, Wellington (NZ); Mark Edward Hearfield, Wellington (NZ)

Correspondence Address: JACOBSON HOLMAN PLLC, 400 SEVENTH STREET N.W., SUITE 600, WASHINGTON, DC, 20004, US

(21) Appl. No.: 10/399,778

(22) PCT Filed: Oct. 18, 2001
(86) PCT No.: PCT/NZ01/00231

(30) Foreign Application Priority Data
Oct. 25, 2000 (NZ) 507752
Feb. 13, 2001 (NZ) 509884
Apr. 24, 2001 (NZ) 511327
Apr. 24, 2001 (NZ) 511328
Sep. 3, 2001 (NZ) 513956
Sep. 26, 2001 (NZ) 514505
Oct. 4, 2001 (NZ) 514643

(51) Int. Cl. B32B 3/00; B32B 3/26; B32B 7/12; B32B 9/00

(52) U.S. Cl. 428/318.4; 428/304.4; 428/316.6; 428/317.1

(57) ABSTRACT

A floor defining structure reliant upon a confinement periphery around a bed of compacted free draining material on which is positioned one or more floor panel support pads. The floor itself is supported directly or indirectly by both the confinement periphery and the pads. The pads are of such a kind that will not provide any wicking upwardly of any moisture from the bed material and are heat insulating in nature. Preferably each pad comprises an insulating material above a damp coarse layer and below a structural layer to which and/or into which the floor defining panel or panels can be fixed by adhesive, nailing and/or screwing.

### TECHNICAL BACKGROUND

The present invention relates to foundation forming procedures and components, subassemblies and, assemblies thereof, related methods, floor structures, methods of providing floor structures, components of floor structures and related apparatus, means and methods.

### BACKGROUND ART

The University of Oregon disclosed in September 1997 in “On-Grade Panel Floor System Report #2—Energy Efficient Industrialized Housing Research Program—Energy Studies in Buildings Laboratory, Centre For Housing Innovation, Department of Architecture, University of Oregon, Eugene, Oreg. 97403—U.S. Department of Energy, Contract No. DEFC51-94R020277 September 1997” an alternative flooring system which it refers to as the “on-grade insulated panel floor system”. The full content of that disclosure is hereby here incorporated by way of reference.

That University of Oregon (Professor Brown) system relies on the use of structural insulated panels. The report states that such panels consist of a foam insulating layer sandwiched between two layers of oriented strand board. Such structural insulated panels are disclosed as appropriate for positioning in a particular pattern on a moisture barrier previously laid over a compacted gravel base to an extent sufficient to receive thereon an array of the structural insulated panels which are in turn then overlaid by oriented strand board that defines the floor surface itself.

### DISCLOSURE OF THE INVENTION

In a first aspect the present invention consists in a floor structure which comprises or includes

a water permeable base,

a plurality of supporting pads positioned on said base, each pad being capable of bearing a weight and each having an upper layer of a kind which allows penetrative attachment (such as by way of screwing or nailing) and/or adhesive attachment, each such pad being formed of a material or materials whereby there is no significant uplift of moisture from said water permeable base to said upper layer, and

a panel or an array of panels attached as a floor surface defining sheet or array of sheets on said pads.

Preferably said floor structure includes a peripheral confinement of said supporting pads.

Preferably said panel or array of panels at least adjacent the periphery of the building envelope in part support the panel or the adjacent panels.

Preferably the water permeable base is defined by a particulate material or materials laid and preferably compacted onto the ground.

Preferably such materials include any one or more of gravel, rock pieces, clinker, crushed concrete, broken glass, plastic chips and ground tires (preferably all substantially devoid of fines).

The top layer of each pad can be of one or more materials which may be a board of any appropriate form (e.g. composite or otherwise and irrespective of whether or not it includes any lignocellulosic fibres or not). For example, options include the composite board options hereinafter described but may alternatively extend to appropriate sheet metals.

Preferably the pad each supports the upper layer with an appropriate insulation material selected from a foam of any of the kinds hereinafter described (including polystyrene foam both extended and/or expanded and polyurethane foam both extruded and/or expanded, wood wool/cement mixtures, stramit board, light weight foamed concrete, honeycombed systems, timber, coak, cork, pulverised municipal waste, coconut husks, recycled composites, tennis balls, corrugated medium etc.).

Preferably each pad includes a damp course bottom layer and/or any other layer should any of the insulating material(s) be likely to be permeable to moisture and particularly where the insulating material(s) had any tendency to wick or otherwise lift moisture upwardly within the pad.

Preferably the peripheral confinement is by any of the means hereinafter described (including the preferred peripheral confinement described in detail hereinafter with reference to the drawings) but may, in part, include a ground wall forming at least part of a periphery, such wall being formed in part of timber, concrete, masonry, steel, a plastics material, a laminated wood or the like.

Preferably the panel or array of panels to define the floor surface itself is supported at least in part by the peripheral confinement periphery and is supported thereon by its being simply laid, driven. caste, keyed, interlocked, dowelled or chemically bound. Other options fall within the scope of the present invention.

In another aspect the present invention consists in a floor structure which comprises or includes

a water permeable base,

a plurality of supporting pads positioned on said base, each said pad having a suitable insulating (e.g. foam) structural layer interposed between an upper layer and an underlying moisture barrier layer, said upper layer being of a kind which allows penetrative attachment (such as by way of screwing or nailing) or attachment by adhesion, and

a panel or an array of panels attached as a floor surface defining sheet or array of sheets on said pads.

In another aspect the present invention consists in a floor structure which comprises or includes

a water permeable base,

a plurality of supporting pads positioned on said base, each said pad having a suitable plastics or closed cell foam structure layer interposed between an upper composite board layer and an underlying moisture barrier layer, and

a composite board layer attached as a floor surface defining sheet or array of sheets on said pads.

Preferably gaps between the floor defining surface sheets are staggered with respect to any gaps between said pads.

Preferably any gaps between the floor defining sheets are caulked (eg; with construction adhesive, acrylic or silicone sealant).

Preferably said base is provided by a particulate material that is not substantially absorbent of moisture, eg; gravel or the like substantially devoid of fines.

Preferably said water permeable base is of rock pieces of a particle size of from 9 mm to 25 mm or of ASTM mesh of U.S. mesh ⅜ to U.S. mesh 1.

Preferably said base is compacted so as to be load bearing.

Preferably said base is to a depth of from 150 to 300 mm.

Preferably said base is confined at least in part by a peripheral structure.

Preferably said peripheral structure is load bearing for supporting and/or locating peripheral walls.

Preferably said pads are of a thickness of from 50 mm to 250 mm with preferably tile foam layer being of a thickness within the range of from 30 mm to 200 mm. A suitable moisture barrier layer of, for example polyethylene sheet or bitumen is from 0.1 mm to 3.0 mm thick whilst the suitable composite board layer thereof is from L)mm to 25 mm thick.

Preferably tile floor surface defining composite board is from 9 mm to 25 mm thick.

Preferably shapes of all board is rectangular or square of, for the pads, of about 1.5 to 13.0 square metres each and for the floor defining of about 1.5 to 15.0 square metres per floor panel.

Preferably said pads are prefabricated by adhesive or other association of the upper composite board layer to said suitable plastics foam or closed cell foam and the provision of a moisture barrier layer on the bottom of said foam.

Preferably said moisture barrier layer is provided by either (i) adhesively or otherwise attaching a preformed moisture barrier sheet, (eg; of polyethylene) or (ii) some laying up on such foam material by spraying, rolling or other appropriate process of an appropriate moisture barrier material (eg; bitumen).

Preferably said upper board layer of each said pad is adhesively affixed to the foam.

Preferably each moisture barrier layer is an adhesively affixed layer of an appropriate sheet material to the foam.

Preferably a water permeable adhesive is used between said foam and said moisture barrier layer (eg; polychloroprene) to allow water egress from between said foam and said underlying water barrier layer.

Preferably said floor defying composite board layer is attached by penetrative attachment (eg; screwing and/or nailing) down into the underlying yet upper layer which is of composite board or sheet metal of said pad(s). Alternatively or as well adhesive may be used.

Preferably the arrays for the floor defining composite boards are any of the arrays referred to in the aforementioned University of Oregon disclosure.

In another aspect the invention consists in a method of forming a floor structure of a building or other structure which results in a floor structure of the present invention.

Preferably said method is performed by compacting a base of rock pieces or the equivalent (eg; gravel without fines),

overlaying the base with a plurality of pads, and

attaching the floor surface defining composite board(s) to said pads.

Preferably said attachment is by means of screwing although if desired other means of attachment as previously described can be utilised.

In still a further aspect the present invention consists in a building or other structure which includes a floor structure as previously defined.

In another aspect the invention is a floor structure which comprises or includes a water permeable base.

a plurality of supporting pads positioned on said base, each said pad having a suitable foam structural layer interposed between an upper layer and an underlying moisture barrier layer, said upper layer being of a kind which allows penetrative attachment (such as by way of screwing or nailing) and/or attachment by adhesion, and

a panel or an array of panels attached as a floor surface defining sheet or array of sheets on said pads.

In another aspect the invention is a floor structure which comprises or includes

a water permeable base,

a plurality of supporting pads positioned on said base, each said pad having a suitable plastics or closed cell foam structure layer interposed between an upper composite board or sheet metal layer and an underlying moisture barrier layer, and

a composite board layer attached as a floor surface defining sheet or array of sheets on said pads,

In another aspect the invention is a method of forming a floor structure of a building or other structure which results in a floor structure as previously defined, and In another aspect the invention is a building or other structure which includes a floor structure as previously defined.

In another aspect the present invention consists in a method of erecting a foundation structure (eg; suitable for a building) which comprises or includes the steps of

(i) defining a load carrying periphery (optionally with additional load carrying members inwardly thereof),

(ii) prior to, during and/or after (i) compacting within said periphery a water permeable base,

(iii) overlaying said water permeable base with a plurality of pads having an insulating character, and

(iv) creating a floor with one or more panels supported (at least in part) directly or indirectly by both said load carrying periphery and the pads having an insulating structure.

As used i herein the insulating stricture of the pads is to both

(i) reduce heat loss down to said water permeable base, and

(ii) reduce water uplift within the pad to the panel or panels of the floor.

Preferably each pad is a pad as herein defined in any of its forms.

Preferably said load defining periphery is of any of the kind herein described.

Preferably the method of creation of a floor as any of the kinds hereinafter described.

In another aspect the present invention consists in a method of erecting a foundation structure (eg; suitable for a building) which comprises or includes the steps of

(a) defining a load carrying periphery (optionally with additional load carrying members inwardly thereof) and a water permeable base therein,

(b) overlaying said water permeable base with an insulating structure at least in part of a suitable plastics or other closed cell foam, and

(c) creating a floor with one or more panels supported (at least in part) directly or indirectly by one or both said load carrying periphery and insulating structure.

Preferably said load carrying periphery is defined by beams at or adjacent the periphery.

Preferably said beams are of wood.

Preferably said periphery is established by driving posts, piles or the like (hereafter “posts”) and thereafter fitting to such posts appropriate beams to define said peripheral structure together with said posts.

Preferably said posts are cut subsequent to driving where needed.

Preferably said posts are checked to accommodate the beam or beams (eg; using a chainsaw).

Preferably the compacting within said periphery of a water permeable base is to a level established by said posts and/or said beams.

Preferably said compacting relies on gravity and screeding and preferably also (at appropriate times) on rolling or tamping or both. Optionally water may also be used.

Preferably (preferably subsequent to said compaction) a peripheral timber plate is fitted to said periphery, such plate to define the underside level of tee floor to be defined by the one or more panels to be used for step (iv).

Preferably said base is provided by a particulate material that is not necessarily substantially absorbent of moisture, eg; gravel or the like substantially devoid of fines.

Preferably said water permeable base is of rock pieces of a particle size of from 9 mm to 25 mm or of ASTM mesh of U.S. mesh ⅜ to U.S. mesh 1 .

Preferably said base is compacted so as to be load bearing.

Preferably said base is to a depth of from 150 to 300 mm.

Preferably said insulating structure includes a plastics close cell foam typified by polystyrene. Other such foams include polyurethane.

Preferably a moisture barrier layer is provided on one and preferably both said load carrying periphery and/or said water permeable base.

Preferably a bitumen damp course or other material is provided to provide a moisture barrier layer on said load carrying periphery preferably below (optionally) fitted peripheral timber plates to underlie (preferably directly) the floor providing panel or panels, such peripheral plates to underlie (preferably indirectly) wall plates of wall structures to be erected thereon.

Preferably the moisture barrier layer on and therefore preferably interposed between said water permeable base and said foam forms part of an assembly of which said foam forms part.

Preferably said insulating structure comprises a plurality of supporting pads each positioned on said water permeable base, each said pad having the foam layer interposed between an upper structural layer (preferably of a composite board or sheet metal) and an underlying moisture barrier layer. Preferably said structural layer is one into which the floor panel or panels can be fixed at least in part by a penetrative means.

Preferably said pads are of a thickness of from 50 mm to 250 mm with preferably the foam layer being of a thickness within the range of from 30 mm to 200 mm. A suitable moisture barrier layer of, for example polyethylene sheet or bitumen is from 0.1 mm to .0 mm thick whilst the suitable composite board layer thereof is from 9 mm to 25 mm thick.

Preferably the floor surface defining composite board or sheet metal is from 9 mm to 25 mm thick.

Preferably shapes of all board is rectangular or square of, for the pads, of about 1.5 to 13.0 square metres each and for the floor defining of about 1.5 to 15.0 square metres per floor panel.

Preferably said pads are prefabricated by adhesive or other association of the upper composite board layer to said suitable plastics foam or closed cell foam and the provision of a moisture barrier layer on the bottom of said foam.

Preferably said moisture barrier layer is provided by either (i) adhesively or otherwise attaching a preformed moisture barrier sheet, (eg; of polyethylene) or (ii) some laying up on such foam material by spraying, rolling or other appropriate process of an appropriate moisture barrier material (eg; bitumen).

Preferably said upper board or sheet metal layer of each said pad is adhesively affixed to the foam.

Preferably each moisture barrier layer is an adhesively affixed layer of an appropriate sheet material to tile foam.

Preferably a water permeable adhesive is used between said foam and said moisture barrier layer (eg; polychloroprene) to allow water egress from between said foam and said underlying water barrier layer.

Preferably said floor defining composite board layer is attached by penetrative attachment (eg; screwing and/or nailing) down into the underlying yet upper layer which is of composite board or sheet metal of said pad(s). Alternatively or as well adhesive may be used.

Preferably said floor is created using a plurality of panels each of a structural material, eg; a composite board.

Preferably gaps between the floor defining surface sheets are staggered with respect to any gaps between said pads.

Preferably any gaps between the floor defining sheets are caulked (eg; with construction adhesive, acrylic or. silicone sealant).

Preferably said composite boards (or panels) are rectangular in shape save for shape adjustment of any such rectangular form required to assume a line along the perimeter, eg; substantially as hereinafter described in more detail.

Preferably the major axes of each such rectangular panel is angled so as to be otherwise than orthogonal or parallel to a said periphery.

Preferably the angling of said floor panel or panels is such as to avoid all risk of abutment of individual panels on a line above a line of abutment or substantial abutment of underlying insulating structures.

Preferably each floor panel or panel is fixed using screws (optionally in addition to adhesive) to the structural panels preferably provided at the top of each individual pack which collectively defines said insulating structure.

An important aspect of the invention is preferably the confinement inwardly of the periphery of the preferably particulate materials to provide said water permeable base and preferably the capability of screeding the level of the compacted base to the level of the preferably beam/post defined periphery and thereafter preferably to rely upon (i) the modular thicknesses of pads to define the insulating structure on said compacted base internally of said periphery and (ii) a subfloor panel timber plate on said peripheral beam to define a common level for the floor panels, eg; preferably of composite board.

In another aspect the present invention consists in a method of erecting a foundation structure (eg; suitable for a building) which comprises or includes the steps of

(i) defining a load carrying periphery (optionally with additional load carrying members inwardly thereof),

(ii) compacting within said periphery a water permeable base,

(iii) overlaying said water permeable base with an insulating structure at least in part of a suitable plastics or other closed cell foam, and

(iv) creating a floor with one or more panels supported (at least in part) directly or indirectly by one or both said load carrying periphery and insulating structure.

In another aspect the present invention consists in a method of erecting a foundation structure (eg; suitable for a building) which comprises or includes the steps of

(a) defining a load carrying periphery (optionally with additional load carrying members inwardly thereof) and a water permeable base therein,

(b) overlaying said water permeable base with an insulating structure at least in part of a suitable plastics or other closed cell foam, and

(c) creating a floor with one or more panels supported (at least in part) directly or indirectly by one or both said load carrying periphery and insulating structure.

Preferably said load carrying periphery is defined by beams at or adjacent the periphery.

Preferably said beams are of wood.

Preferably said periphery is established by driving posts, piles or the like (hereafter “posts”) and thereafter fitting to such posts appropriate beams to define said peripheral structure together with said posts.

Preferably said posts are cut subsequent to driving where needed.

Preferably said posts are checked to accommodate the beam or beams (eg; using a chainsaw).

Preferably the compacting within said periphery of a water permeable base is to a level established by said posts and/or said beams. Preferably said compacting relies on gravity and screeding and preferably also (at appropriate times) on rolling or tamping or both. Optionally water may also be used.

Preferably (preferably subsequent to said compaction) a peripheral timber plate is fitted to said periphery, Such plate to define the underside level of the floor to be defined by the one or more panels to be used for step (iv).

Preferably said base is provided by a particulate material that is not necessarily substantially absorbent of moisture, eg; gravel or the like substantially devoid of fines.

Preferably said water permeable base is of rock pieces of a particle size of from 9 mm to 25 mm or of ASTM mesh of U.S. mesh ⅜ to U.S. mesh 1.

Preferably said base is compacted so as to be load bearing.

Preferably said base is to a depth of from 150 to 300 mm.

Preferably said insulating structure includes a plastics close cell foam typified by polystyrene. Other such foams include polyurethane. Preferably a moisture barrier layer is provided on one and preferably both said load carrying periphery and/or said water permeable base.

Preferably a bitumen damp course or other material is provided to provide a moisture barrier layer on said load carrying periphery preferably below (optionally) fitted peripheral timber plates to underlie (preferably directly) the floor providing panel or panels, such peripheral plates to underlie (preferably indirectly) wall plates of wall structures to be erected thereon.

Preferably tie moisture barrier layer on and therefore preferably interposed between said water permeable base and said foam forms part of an assembly of which said foam forms part.

Preferably said insulating structure comprises a plurality of supporting pads each positioned on said water permeable base, each said pad having the foam layer interposed between an upper structural layer (preferably of a composite board or sheet metal) and an underlying moisture barrier layer. Preferably said structural layer is one into which the floor panel or panels can be fixed at least in part by a penetrative means.

Preferably said pads are of a thickness of from 50 mm to 250 mm with preferably the foam layer being of a thickness within the range of from 30 mm to 20 mm. A suitable moisture barrier layer of, for example polyethylene sheet or bitumen is from 0.1 mm to 3.0 mm thick whilst the suitable composite board layer thereof is from 9 mm to 25 mm thick or metal sheet of at least 5 mm thick.

Preferably the floor surface defining composite board or sheet metal is from 9 mm to 25 mm thick.

Preferably shapes of all board is rectangular or square of, for the pads, of about 1.5 to 13.0 square metres each and for the floor defining of about 1.5 to 15.0 square metres per floor panel.

Preferably said pads are prefabricated by adhesive or other association of the upper composite board or sheet metal layer to said suitable plastics foam or closed cell foam and the provision of a moisture barrier layer on the bottom of said foam.

Preferably said moisture barrier layer is provided by either (i) adhesively or otherwise attaching a preformed moisture barrier sheet, (eg; of polyethylene) or (ii) some laying up on such foam material by spraying, rolling or other appropriate process of an appropriate moisture barrier material (eg; bitumen).

Preferably said upper board layer of each said pad is adhesively affixed to the foam.

Preferably each moisture barrier layer is an adhesively affixed layer of an appropriate sheet material to the foam.

Preferably a water permeable adhesive is used between said foam and said moisture barrier layer (eg; polychloroprene) to allow water egress from between said foam and said underlying water barrier layer.

Preferably said floor defining composite board layer is attached by penetrative attachment (eg; screwing and/or nailing) down into the underlying yet upper layer which is of composite board or sheet metal of said pad(s). Alternatively or as well adhesive may be used.

Preferably said floor is created using a plurality of panels each of a structural material, eg; a composite board.

Preferably gaps between the floor defining surface sheets are staggered with respect to any gaps between said pads.

Preferably any gaps between the floor defining sheets are caulked (eg; with constriction adhesive, acrylic or silicone sealant).

Preferably said composite boards (or panels) are rectangular in shape save for shape adjustment of ally such rectangular form required to assume a line along the perimeter, eg; substantially as hereinafter described in more detail.

Preferably the major axes of each such rectangular panel is angled so as to be otherwise than orthogonal or parallel to a said periphery.

Preferably the angling of said floor panel or panes is such as to avoid all risk of abutment of individual panels on a line above a line of abutment or substantial abutment of underlying insulating structures.

Preferably each floor panel or panel is fixed using screws (optionally in addition to adhesive) to the structural panels preferably provided at the top of each individual pad which collectively defines said insulating structure.

An important preferred aspect of the invention is preferably the confinement inwardly of the periphery of the preferably particulate materials to provide said water permeable base and preferably the capability of screeding the level of the compacted base to the level of the preferably beam/post defined periphery and thereafter preferably to rely upon (i) the modular thicknesses of pads to define the insulating structure on said compacted base internally of said periphery and (ii) a subfloor panel timber plate on said peripheral beam to define a common level for the floor panels, eg; preferably of composite board or sheet metal.

In still a further aspect the present invention consists in a method of erecting a foundation structure (eg; for a building) which comprises the steps of

defining a water permeable base,

supporting a plurality of rectangular or square supporting pads on said base, each said pad having a suitable foam structural layer interposed between an upper layer and an underlying moisture barrier layer, (said upper layer being of the kind which allows (a) penetrative attachment such as by screwing or nailing and/or (b) attachment by adhesion), and

laying and attaching an array of panels on said pads, said panels being essentially rectangular or square (or truncations thereof to provide at least one oblique edge) with the array of such panels oblique to at least most of the edges of the underlying supporting pads.

Preferably said method results in a floor structure.

Preferably said supporting pads are as previously defined.

Preferably each panel is substantially as previously defined.

Preferably said water permeable base is as previously defined.

In still a further aspect the present invention consists in a floor structure substantially as herein described with reference to any of the accompanying drawings.

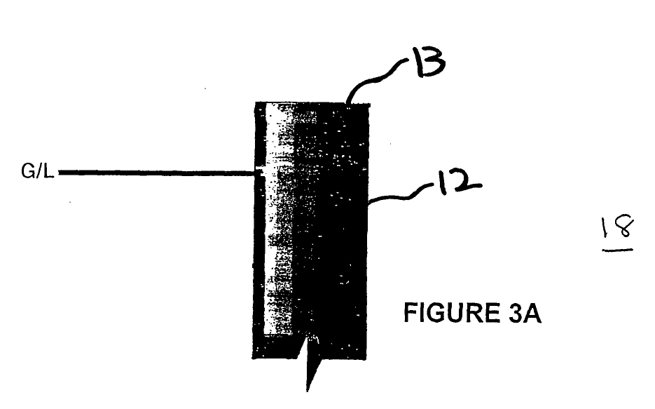

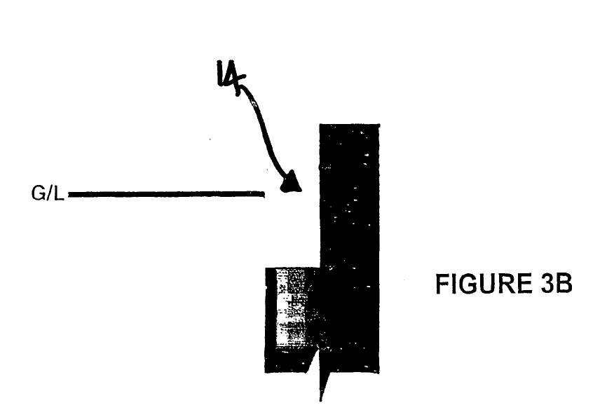

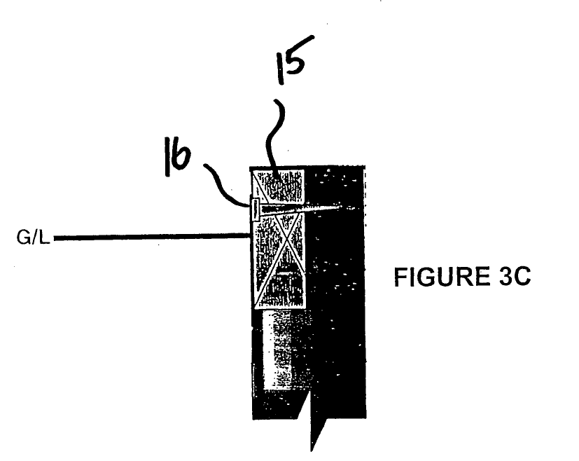

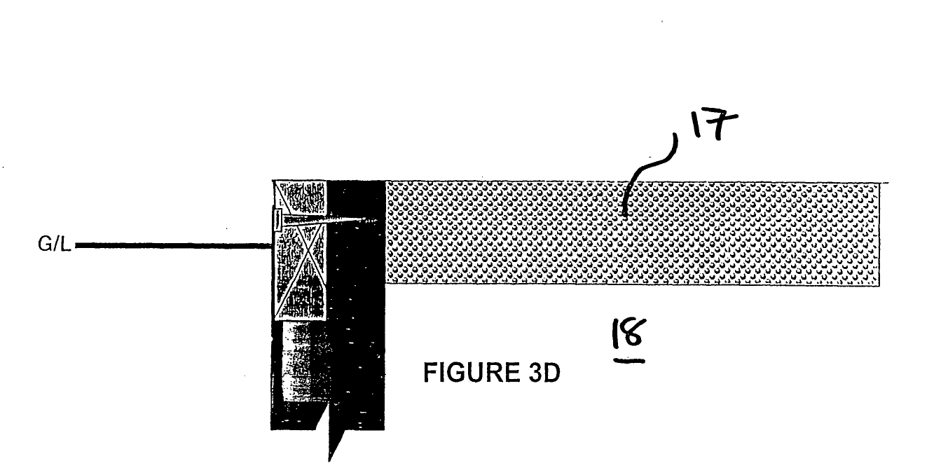

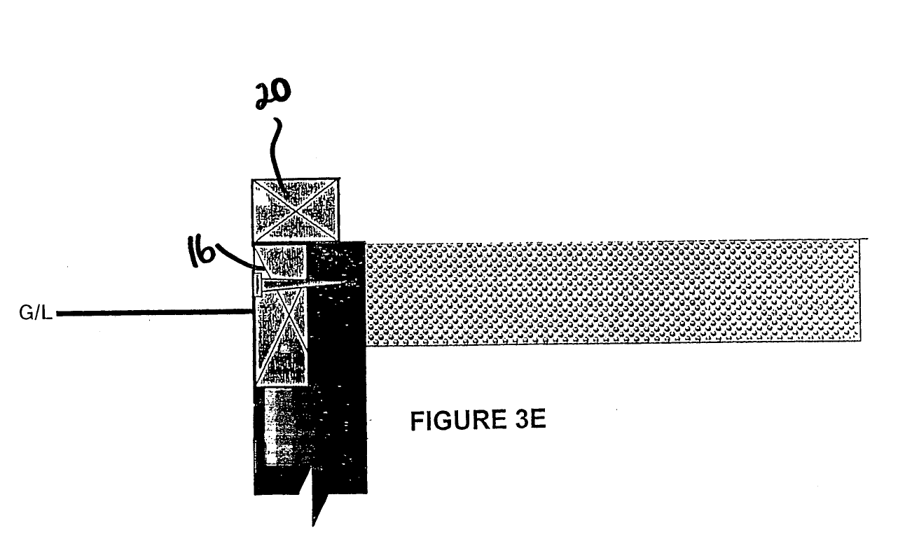

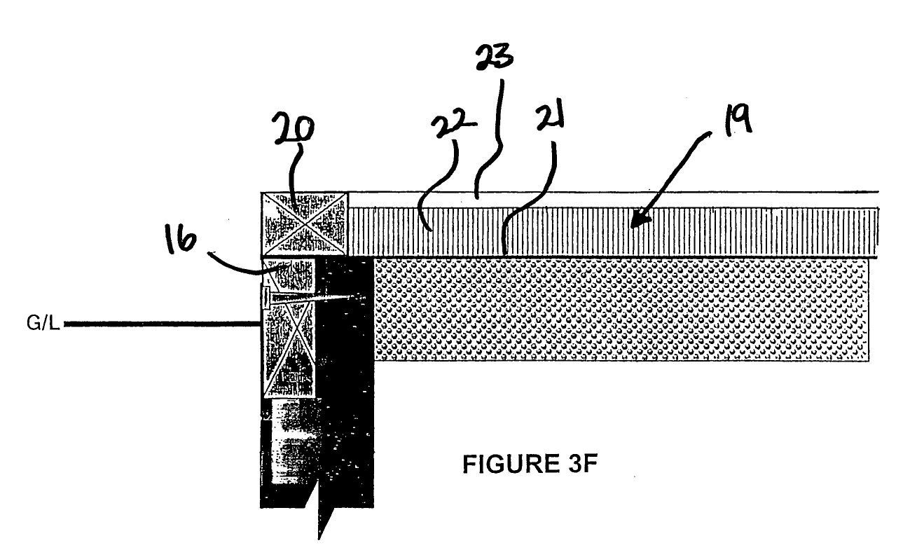

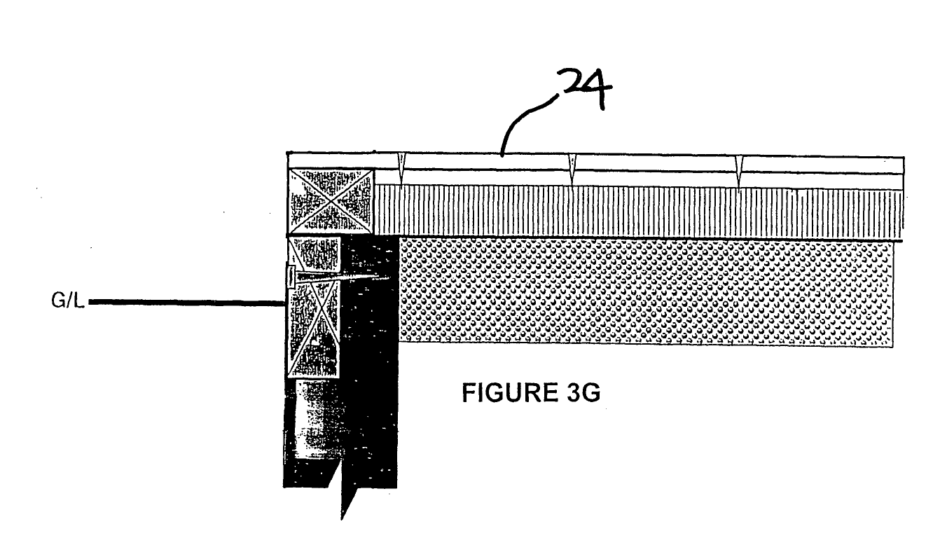

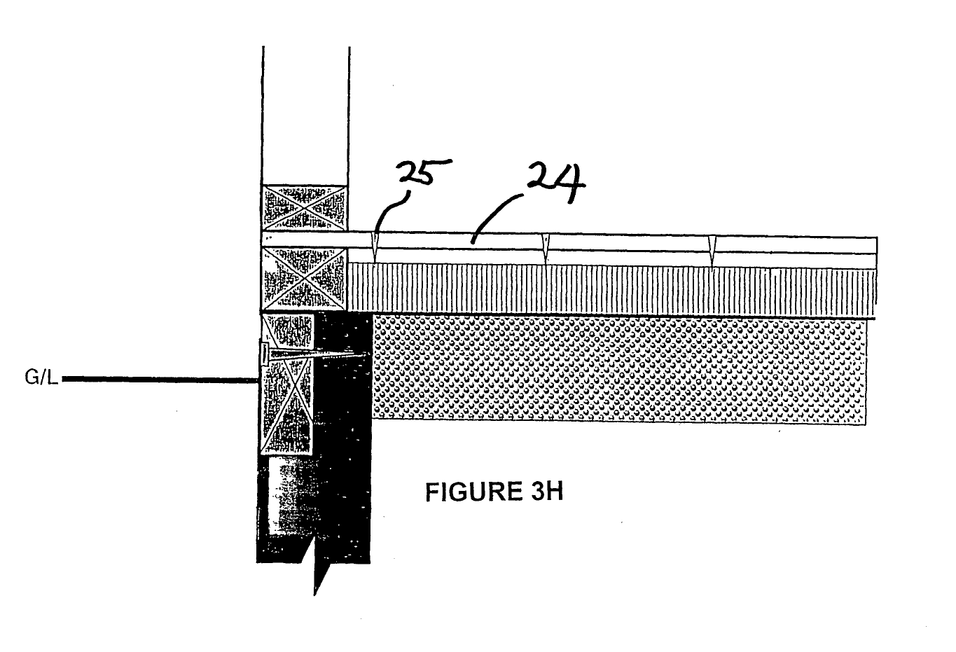

In still a further aspect the present invention consists in a foundation of floor structure substantially as herein described with reference to the periphery and any one or more of FIGS. 3 onwards.

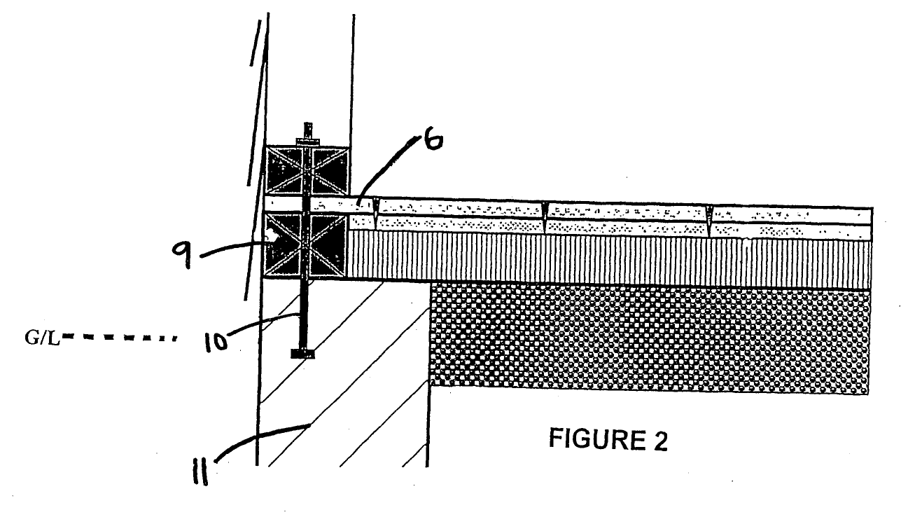

In still a further aspect the present invention consists in method of defining a floor or foundation for a structure or building when performed substantially as herein described with reference to any one or more of the accompanying drawings and particularly any one or more of FIGS. 2 onwards.

In still a further aspect the present invention consists in a method of forming a periphery or a periphery thus formed suitable for use in a floor structure or a foundation structure as aforesaid.

In yet a further aspect the present invention consists in a floor and foundation periphery substantially as herein described with reference to any one or more of the accompanying drawings.

In a further aspect the present invention consists in a floor of an array of panels supported peripherally on a structure dependent from driven piles and centrally of said driven piles by a plurality of pad like structures that are supported on a water permeable base of a particulate material on the ground.

As used therein and herein the term “composite board” in respect of either said upper composite board layer of each pad or the composite board layer which defines the floor surface can be of any type preferably utilising wood fibres.

In this respect the composite board of the pads may differ from the composite board of the floor defining surface or may be similar albeit possibly of different thickness. For example, oriented strand board as utilised by Professor Brown may be utilised or, having regard to its greater availability in New Zealand, particle board such as high density particle board (PYNEFLOOR™ supplied by Fletcher Wood Panels, Kumeu Plant) or MDF (such as supplied by Fletcher Wood Panels Taupo plant) may be utilised. For example, particle board of thickness 9 mm to 25 mm or MDF of thickness from 9 mm to 25 mm can be used for the upper composite board layer of the pads. Similarly, for the floor defining surface, particle board of 9 mm to 25 mm thickness or MDF of 9 mm to 25 mm thickness may be used. Other material for either use includes oriented strand board (OBS) or plywood.

The term “composite board” can also include

(i) any composite material which utilises wood fibres such as, by way of example only,

(a) high density particle board,

(b) medium density fibreboard,

(c) oriented strand board,

(d) plywood, any

(e) any composite of a plaster, gypsum or the like material and any fibrous material such as a wood fibre including gypsum product (eg, as developed by and/or available from U.S. Gypsum), and/or

(ii) any fibre cement or other cementitious material (eg; Such as that of James Hardie & Co. New Zealand and Australia).

Of course sheet metal or other material may be substituted for any such composite or other board in the pads or pad.

The term “board” is sometimes used herein in respect of panel forms. Other composite boards that may be utilised include high density fibre board (hardboard) and medium density particle board (SUPERFLAKE™). Any such composite boards may be coated to ensure some degree of weather resistance, eg; for example, the composite board to define the floor surface if it likely to be exposed to the elements for some period of time may be provided with a coating of, for example, acrylic sealer.

As used herein “panels” are not necessarily composite panels that include a wood fibre but preferably are self supporting panels.

Still other materials useful as the “board” or as a “layer” is a material of any of the kinds previously defined in respect of the floor structure plurality of pads and/or the panel or array of panels (eg; fibre cement et al.).

As used herein the term “suitable plastics or closed cell foam stricture layer” includes any suitable material whether a plastics material or not capable of providing such an insulative foam unlikely to be degraded over the period of usage. Preferably however the suitable plastics material is a closed cell foam of polystyrene or, for example, polyurethane.

The term “board” therefore is used herein in respect of many types of panel forms including those without wood fibres (eg; possibly even metal sheet). Other composite boards that may be utilised include high density fibre board (hardboard) and medium density particle board (super flange). Any such composite boards may be coated to ensure some degree of weather resistance, eg; for example, the composite board to define the floor surface if it likely to be exposed to the elements for some period of time may be provided with a coating of, for example, acrylic sealer.

### DETAILED DESCRIPTION OF THE INVENTION

Preferred forms of the present invention will now be described with reference to the accompanying drawings in which:

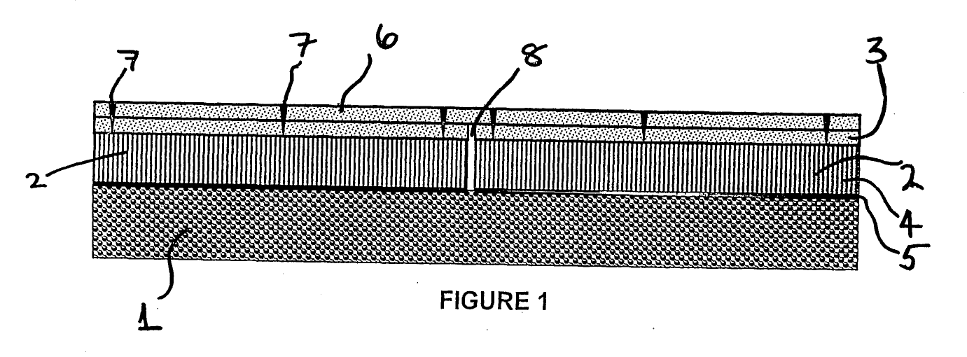

FIG. 1 is a diagrammatic side elevational view of a floor structure in accordance with the present invention showing diagrammatically (as if in section) a plurality of screws holding the floor defining surface layer on to the composite board or sheet metal of each of two depicted pads. each of the two pads being positioned with a gap there between (not sufficiently closed as to cause any capillary action or wicking) and which are supported with their moisture barrier layer directly on a base prepared from a compacted gravel (no lines),

FIG. 2 is a similar view to that of FIG. 1 but showing just one of several options for a peripheral confinement structure (in this case a concrete block or poured concrete surround foundation) on which can be supported and located a perimeter timber plate on to which the wall is directly supported, preferably the floor defining surface composite board panel extending over such plate,

FIG. 3 shows a most preferred confinement and erection sequence,

FIGS. 3A through 3H being a sectional view of a sequence leading from

(i) FIG. 3A—peripheral post driving and cut off to a desired level relative to the ground level and to each other, such posts being of any appropriate horizontal section,

(ii) FIG. 3B—checking of each post to accommodate a peripheral beam (such a beam if desired being slotted into or inwardly as opposed to outwardly checked into such posts),

(iii) FIG. 3C—the positioning with appropriate screwing and/or nailing of the peripheral beam into the checked in posts,

(iv) FIG. 3D—the compaction of the water permeable base (which can be during and/or after (i) or (ii)) on to the exposed ground internally of the periphery,

(v) FIG. 3E (which can be simultaneously with or after the step of FIG. 3F)—positioning a peripheral timber plate to define a level on to which a flooring panel or panels can be positioned,

(vi) FIG. 3F—positioning the insulating structure on the water permeable base (which base preferably is to the level of the posts and the peripheral beam),

(vii) FIG. 3G—attaching flooring panels to the insulating structure and peripheral timber plate, and

(viii) FIG. 3H positioning a wall plate on the periphery of the floor and thereafter continuing the erection of the building,

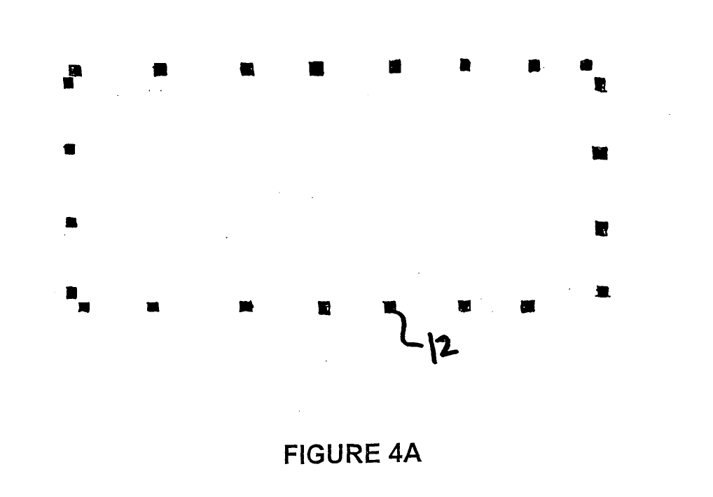

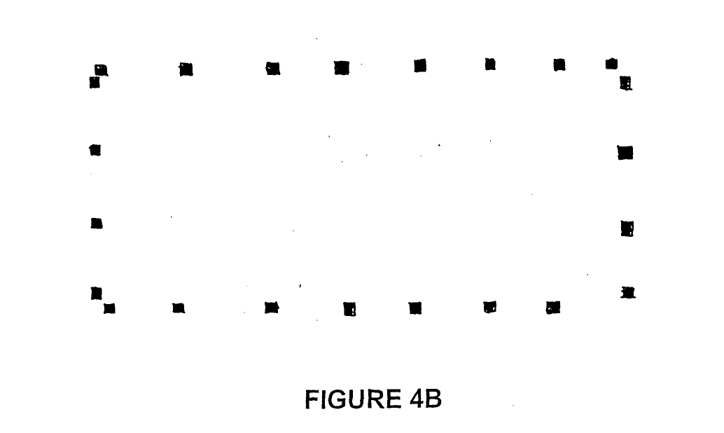

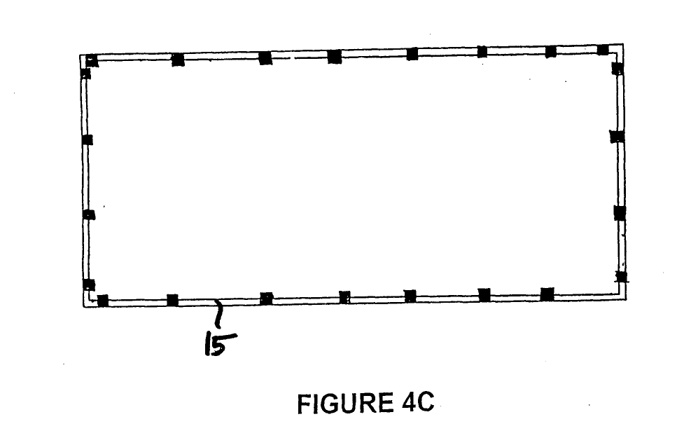

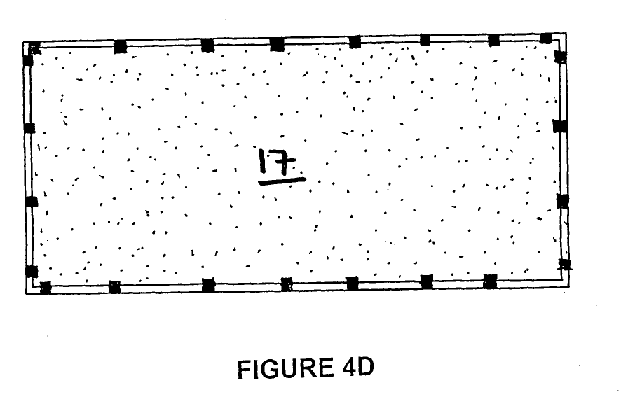

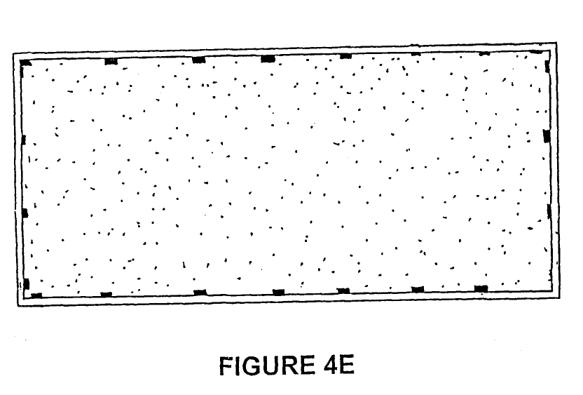

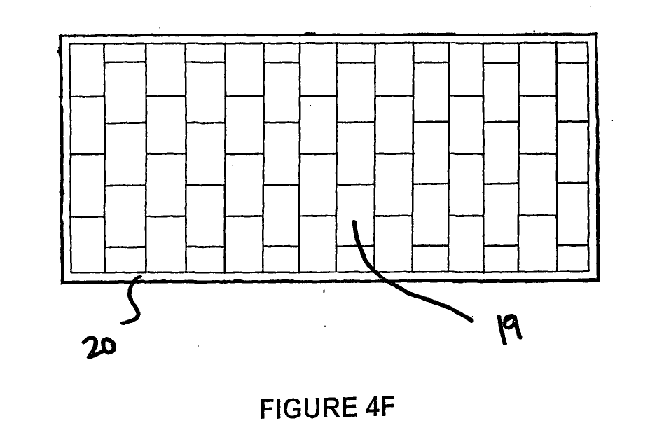

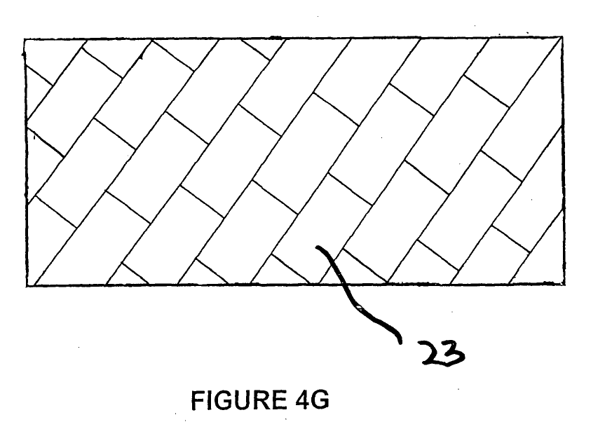

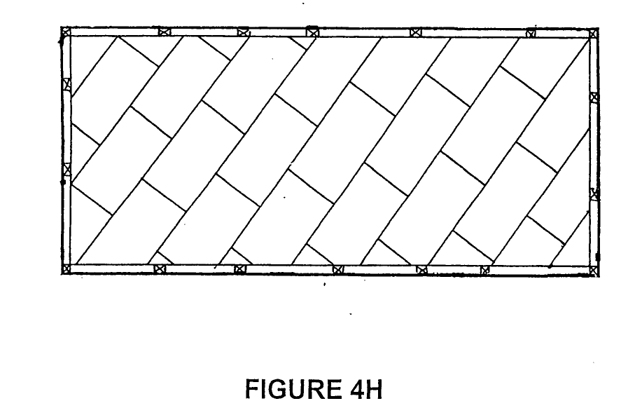

FIG. 4A through 4H correspond respectively to each of FIGS. 3A to 3H but are shown in plan, FIGS. 4F and 4G showing how preferably pads as aforesaid are utilised with lines of proximity and/or abutment preferably parallel to at least one or more of the peripheries and with the overlying flooring panel or panels (preferably rectangular or some oblique truncation thereof) being laid as an array so as to have caulkable abutments not as a line coinciding with any such pad lines of proximity, ie, preferably there is the use of oblique laying of one or other of the set of pads and the set of flooring panels,

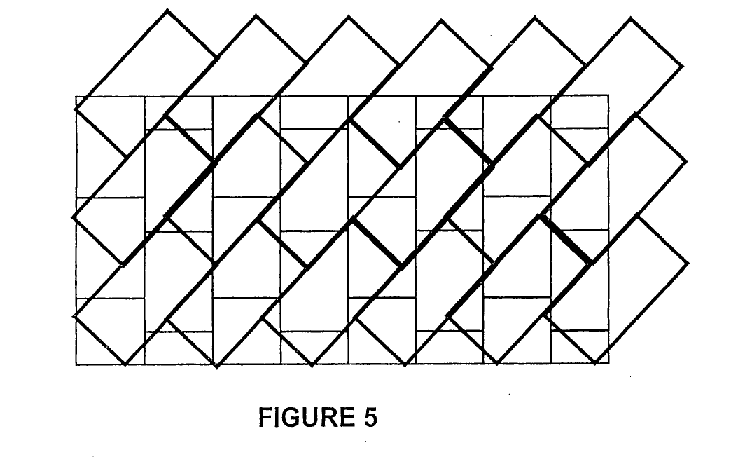

FIG. 5 is a diagram showing how the extraneous material of standard rectangular sheets provides sufficient materials to make up around the perimeter thereby ensuring little wastage of material,

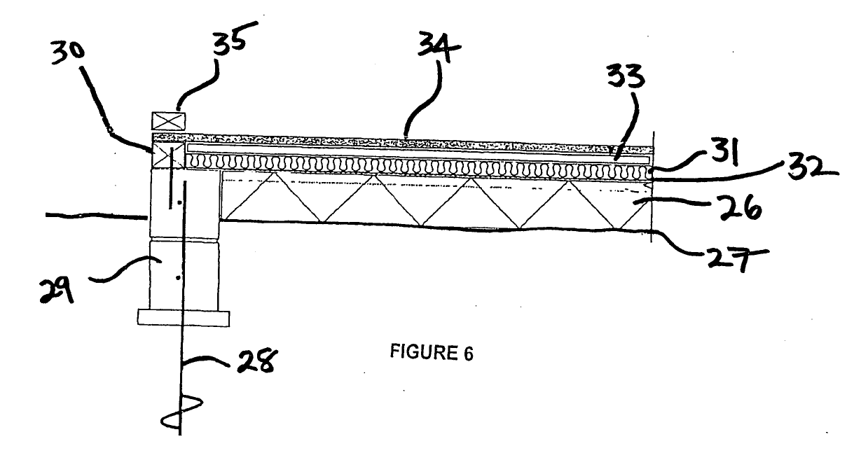

FIG. 6 is a diagrammatic sectional view showing an alternative where a concrete block periphery anchored by a ground auger is utilised,

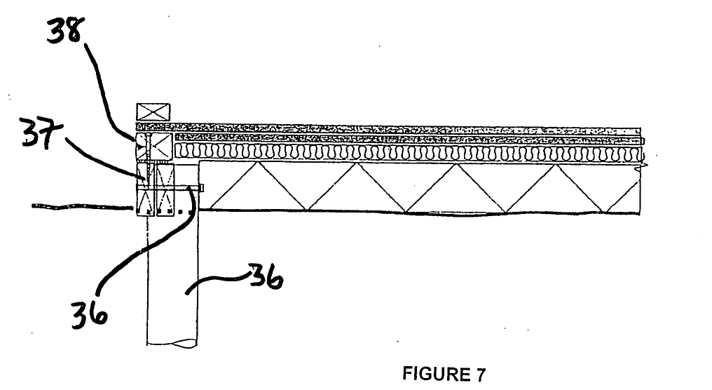

FIG. 7 shows yet a further alternative peripheral confinement where whilst using a driven timber pile arrangement on which are supported timber beams a coach screwed peripheral plate of timber is utilised over a building paper or the equivalent,

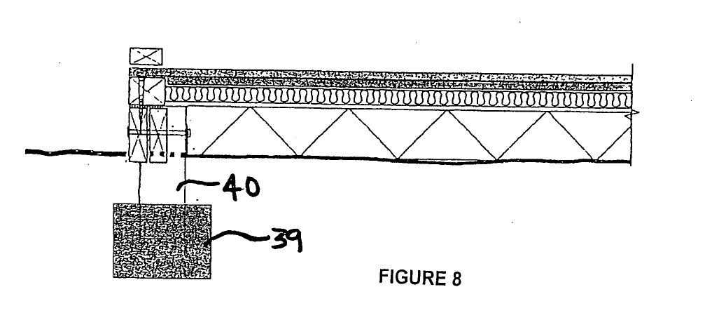

FIG. 8 shows yet a further arrangement where a house pile is supported from a concrete pile fitting at the periphery and thereafter there is an arrangement as in FIG. 7,

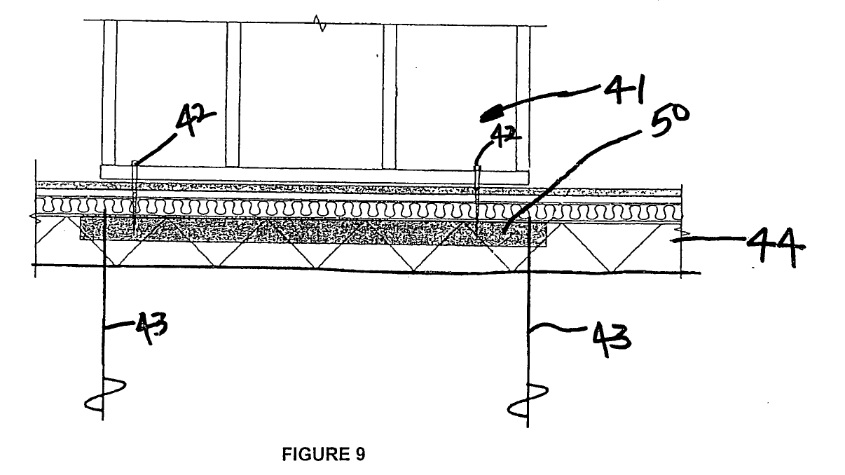

FIG. 9 shows the use of braced walls internally of a structure made according with the present invention where auger ground anchors are utilised to anchor a timber house pile type timber anchor plate engaged to the augers and bedded in the top course with a view to providing a means for coach bolt anchoring down thereto of the bracing wall,

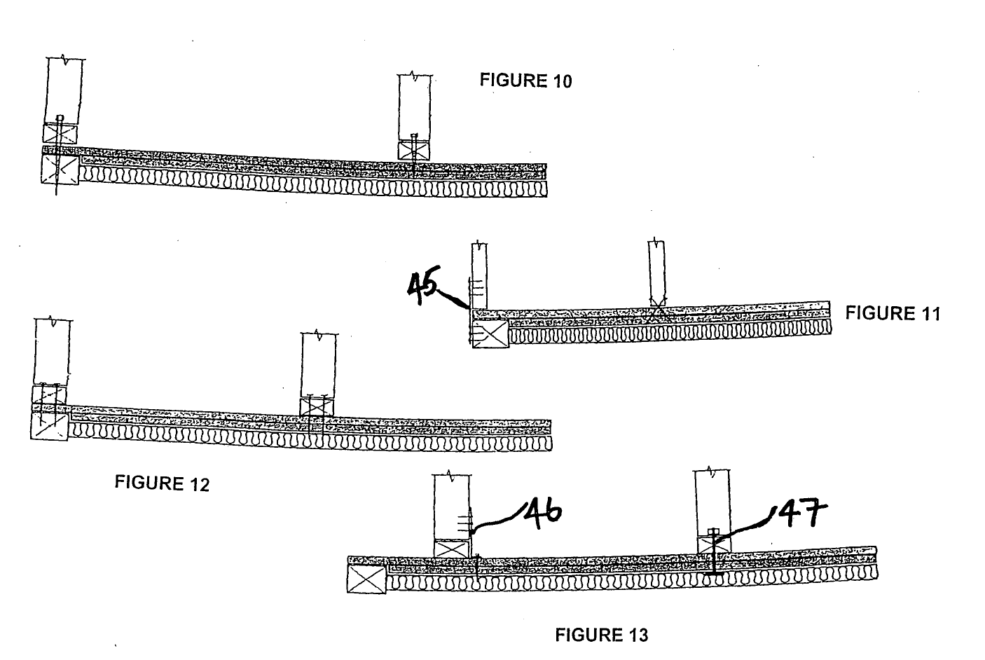

FIG. 10 shows an arrangement suitable for solid walls,

FIG. 11 shows a system suitable for framed walls,

FIG. 12 shows a system suitable for framed walls,

FIG. 13 shows a system also suitable for framed walls,

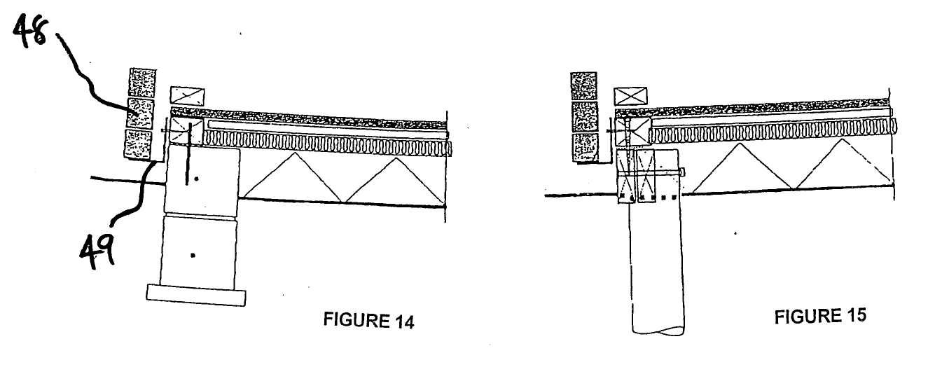

FIG. 14 shows concrete block edging and arrangements for supporting a clay or concrete masonry veneer, and

FIG. 15 shows a variation of the arrangement in FIG. 14 but utilising timber edging as previously defined.

In a preferred form of the present invention the arrangement is as shown in FIG. 1 where a base 1 is a 150 mm compacted gravel (no fines) of U.S. mesh size ¾.

Each pad 2 comprises an upper composite board layer 3, an interposed polystyrene foam layer 4 and an underlying moisture barrier layer 5. The materials of each of the layers 3, 4 and 5 are as follows:

the composite board layer 3—9 to 25 mm particle board or MDF.

the plastics foam layer 4—30 to 200 mm polystyrene foam,

the moisture barrier layer 5—0.1 to 3.0 mm thick polyethylene sheeting or bitumen.

Preferably the adhesive or other bonding between said foam structure and the underlying moisture barrier layer is such as to allow permeability of water in the plane between said foam structure layer and the underlying moisture barrier layer. This could be achieved by use of a water permeable adhesive or the use of an array of adhesive between the layers (irrespective of whether or not such adhesive is water permeable or not water permeable) or could simply be an in mould attachment of the foam to the moisture barrier layer e.g. as might be achieved if the moisture barrier layer was applied as a sheet or coating in the mould in which the foam is blown.

Preferably layer 3 is adhesively affixed to the foam 4 by an adhesive such as polychloroprene.

Preferably the layer 5 is attached to the foam 4 by a water permeable adhesive such as polyclhloroprene or liquid applied bitumen.

Preferably the floor defining surface 6 is of 9 to 25 mm thick particle or MDF board attached by penetrative fixing (for example, nailing and/or screwing by screws 7) at 200 to 400 mm centres both ways.

Where sheets 6 are not fully co-extensive of the floor structure they are brought into juxtaposition as an array staggered such as to minimise the degree of coincidence with the gaps 8 between individual pads 2. Any mating between sheets 6 is preferably caulked to minimise water penetration down on to the particle board or other composite material providing the layers 3 of each pad 2.

In FIG. 2 a similar floor structure to that depicted is shown but here the sheet 6 extends out over a timber wall plate 9 which is supported by an embedded bolt 10 in a peripheral concrete or concrete block confinement periphery 11. The ground level is denoted by the broken line indicated as “G/L”.

The preferred method in accordance with the present invention is performed as shown in FIGS. 3, 4 and 5 but preferably reliant upon pads as shown in FIGS. 1 and 2 rather than alternatives for the insulating floor structure (such as those mooted by Professor Brown). Whilst other insulating structures fall within the ambit of the present invention, preferably each structure is such or is used in such a way that there damp proofing somewhere between the water permeable base and the flooring structure is to be attached or on which it is to rest.

Optionally at least a partial water barrier is provided on the periphery preferably by a reliance upon building paper, bitumen strip or polythene Film or the like materials which interposes between said beam and post and the overlying peripheral plate or on such a timber plate or in addition also on such a peripheral timber plate.

In the preferred form of the present invention a post 12 (preferably of a ground treated timber of any appropriate cross section (eg; round or square)) is driven on the periphery. The periphery can be defined by appropriate string lines as can the levels. The levels can alternatively be set by laser or other appropriate levelling means. The level at 13 can be cut off by appropriate means or the post can be driven to that level.

Thereafter if desired a check out 14 can be cut by an appropriate saw (eg; a circular saw or a chain saw) thereby defining a check in into which a peripheral beam 15 can be fitted by appropriate screws or bolts (eg; coach screws, bolts or the like 16).

Simultaneously with or preferably after the periphery is fully defined the water permeable base 17 is defined on the ground 18.

Whilst reference is being made to the compacted water permeable base being defined after the defining of the periphery parts, of course the base can be compacted in part, if desired, prior to the completion of the periphery. Certainly some of the particulate material can be inserted there even prior to the creation of the periphery.

The periphery however in its final form is preferably desired for the level of the fully compacted materials.

Once the level of the compacted materials has been set it is possible thereafter to position the insulating structures 19 thereon.

Preferably such location of the insulating structures 19 is before, after and/or simultaneously with the provision of a peripheral timber plate 20 on the peripheral beam 16.

The peripheral plate 20 can be provided by any appropriate means. Each pad has positioned as 21 under the foam layer 22. Attached adhesively to the foam layer 22 of each pad is the structural or other layer 23. The flooring panels 24 can be attached by appropriate fixing means, eg; screws 25 to the layer 23.

FIGS. 3A through 3H and 4A through 4H shows the preferred arrangement whereby an appropriate structure can be formed.

FIG. 5 shows flow the pads with a layer 23 of, for example, 2400×1800×20 mm particle board sheets (or part thereof) can be covered with obliquely laid 3600×1800×20 mm particle board (or part thereof) to avoid any coincidence of lines of proximity or abutment thereby ensuring appropriate strength for the structure.

Preferably the resultant structure from a process of the preferred invention as described is one as to give a water permeable base of about 150 mm of 10/15 gap compacted gravel (with no lines) on which an insulating layer of particle board (20 mm) adhered to polystyrene (50 mm) and adhered to a water barrier membrane (as aforesaid) is positioned to match the level of a preferred 100×75 mm timber plate. Such a timber plate is positioned on the 200×75 mm timber ground beam fixed by coach screw(s) or bolts to tile piles or posts. Preferably such piles are 140mm diameter (or the square equivalent piles) preferably driven at about 2 m centres.

The frame can be of any conventional type capable of being positioned on the thus defined floor surface.

Preferably the floor is defined by 20 mm particle board nailed to the 10/20 mm particle board of each pad at 300 mm centres both ways. All joints in the preferably obliquely angled particle board of the floor panels is caulked as aforesaid.

The present invention therefore in its various forms provides a variety of different foundations capable of being quickly and effectively erected irrespective of weather conditions and upon which quickly ongoing building can take place. For instance for a normal dwelling, about 2 hours of post driving only is required. Even whilst that post driving continues at least one or more of the peripheral beams can be being installed by on site builders. Of course much of the permeable base material could have been tipped by a truck into the centre of the intended periphery to enable easy spreading thereof to the periphery without delivery delay.

Thereafter appropriate screed levelling and/or compaction, (compaction as being used herein being used in the broadest possible sense) would take place.

In tile arrangements depicted in FIGS. 6 through 15 the zig zagged layers 26 typified by that of FIG. 6 is a layer on the ground 27 of, for example, a compacted gravel —e.g. preferably a minimum of about 100 mm deep, 20 mm domestic top course overlayed in turn (by the layer above the broken line) of 10 mm drainage bedding material compacted and screed level.

As shown in the arrangement of FIG. 6 for example. peripheral 200 mm concrete blocks with appropriate 2-D 12 reinforcing bars are anchored into the ground by a ground auger 28, the concrete blocks 29 have overlying thereon part of the pads of the present invention or a large pad support for the whole floor as well as supporting a peripheral timber plate 30.

The timber plate 30 is preferably a 100×75 H1 timber anchor plate bolted to the blocks with an appropriate anchor at 1400 mm spacings (e.g. an M12×150 Excalibur anchor) plus an additional anchor at each brace wall.

In the arrangement as shown in FIG. 6, preferably each pad comprises 45 mm of polystyrene 31 to which a bottom surfacing of DPM 32 has been preglued and over which has been preglued to the polystyrene 31 a 10 or 20 mm PYNEFLOOR™ panel 33 oriented orthogonally with, for example, 3 mm gaps between sheets.

The top floor defining surface is a similar composite board to that of 33 i.e. 20 mm PYNEFLOOR™ panels 34 oriented diagonally with joints taped for weather seal and nailed to tile layer provided by the PYNEFLOOR™ sheets 33.

It can be seen that a peripheral timber plate 35 can then be affixed peripherally of the floor level surface defined by the sheets 34 some minimum of 225 mm above the ground level 27.

FIG. 7 utilises similar componentry to that of FIG. 6 but here as previously described in respect of other embodiments a driven timber pile 36 is utilised. Such a timber pile is at 2 metre spacing starting 500 mm from corners with pile installation to NZ Standard 3604. An appropriate pile is a 140 mm diameter pile capable of being driven to 100 mm/blow final set with a 200 kg hammer to provide a drop height of 2.4 m.

Shown anchored by appropriate stainless steel coach bolt (e.g. M12 s/s coach bolt) 36 are a pair of 150×50 B5 timber edge beams 37 to which is affixed a 100×75 H1 timber anchor plate 38 fixed through a DPC moisture barrier by use of, for example, M12×180ss coach screws.

FIG. 8 shows a further alternative but here unlike the arrangement as in FIG. 7 a concrete pile footing 39 is utilised from which upstands a 125×125 house pile 40. Thereafter tile arrangements are as in FIG. 8.

FIG. 9 shows a bracing wall 41 anchored by, for example, coach screws 42 to an embedded timber house pile anchor plate 43. Preferably the coach screws 42 through the bottom plate of the bracing wall 41 (which can be any typical proprietary system) is an M12×200 coach screw passing through the bottom plate of the bracing wall and into the anchor plate 50.

As seen auger ground anchors 43 preferably anchor the anchor plate 50. Preferably the anchor plate 50 is a 125×125 timber house pile (H5 treated) threaded over the augers 43 and bedded in the top course 44. Preferably a nut and 100×100 washer is recessed into the anchor plate 43 to hold the augers 43 in conjunction with the anchor plate 50.

FIGS. 10 through 13 shows a variety of different wall support systems. FIG. 10 shows a peripheral wall where a coach screw passes through a bottom timber plate and into a perimeter anchor. The internal wall of FIG. 10 has a coach screw through the bottom plate and into the particle or MDF board. Alternatively however such an anchor bolt could pass right through and into an anchor plate as in FIG. 9.

FIG. 11 shows a solid wall type arrangement where, for example, a metal nail plate 45 is utilised for anchoring the wall to a peripheral anchor plate whilst internal walls could be anchored by use of skew nails through the bottom of the wall and into the particle board.

FIG. 12 shows a variation to the framed wall arrangements of FIGS. 9 and 10 where nails are utilised through the bottom plates and into (in the case of the perimeter or peripheral wall) the perimeter anchor plate and in the case of the internal wall simply into the particle board from the bottom plate.

FIG. 13 shows a still further variation for internal framed walls and one case showing the use of a folded metal nail plate 46 and in the other instance a T-shaped toggle bolt through the bottom plate. Such a toggle bolt 47 is preferably threaded down and under the particle board reliant upon a slotted hole.

FIG. 14 shows concrete block edging used in conjunction with a clay or concrete masonry veneer 48 supported on metal shelf angles 49. Similarly in conjunction with timber edging as previously described a similar arrangement is shown in FIG. 15.

1. A floor structure which comprises or includes
a water permeable base,
a plurality of supporting pads positioned on said base, each pad being capable of bearing a weight and each having an upper layer of a kind which allows penetrative attachment (such as by way of screwing or nailing) and/or adhesive attachment, each such pad being formed of a material or materials whereby there is no significant uplift of moisture from said water permeable base to said upper layer, and
a panel or an array of panels attached as a floor surface defining sheet or array of sheets on said pads.

2. A structure as claimed in claim 1 wherein said floor structure includes a peripheral confinement of said supporting pads.

3. A structure as claimed in claim 2 wherein a structure providing said peripheral confinement in part supports the panel or array of panels.

4. A structure as claimed in claims 1 to 3 wherein the water permeable base is defined by a particulate material or materials laid and compacted onto the ground.

5. A structure as claimed in claim 4 wherein said particulate material(s) include(s) any one or more of gravel, rock pieces, clinker, crushed concrete, broken glass, plastic chips and ground tires.

6. A structure of claim 4 or 5 wherein said particulate material(s) is(are) substantially devoid of fines.

7. A structure of any one of claims 1 to 6 wherein at least one said upper layer is a board sheet.

8. A structure of claim 7 wherein said board sheet is of a composite material.

9. A structure of claim 8 wherein said composite material includes lignocellulosic fibres.

10. A structure of any one of claims 1 to 6 wherein at least one said upper layer is a metal sheet.

11. A structure of any one of claims 1 to 10 wherein each pad supports its upper layer with all insulation material.

12. A structure of claim 11 wherein said insulation material is selected from a foam, wood wool/cement mixtures, stramit board, light weight foamed concrete, honeycombed systems, timber. coak. cork, pulverised municipal waste, coconut husks. recycled composites, tennis balls and a corrugated medium.

13. A structure of claim 11 or 12 wherein tile insulation material is a plastics foam.

14. A structure of claim 14 wherein said plastics foam is a polyurethane or a polystyrene.

15. A structure of any one of the preceding claims wherein each pad includes a damp course bottom layer.

16. A structure of any one of the preceding claims wherein tile peripheral confinement at least in part, includes a ground wall.

17. A structure of any one of claims 1 to 16 wherein said peripheral confinement includes a horizontal beam or other runner raised above the ground.

18. A structure of claim 16 or 17 wherein at least part of the panel or array of panels to define the floor surface itself is supported at least in part by the peripheral confinement periphery and is supported thereon by its being simply laid, driven, cast, keyed, interlocked, dowelled or chemically bound thereon.

19. A floor structure which comprises or includes
a water permeable base,
a plurality of supporting pads positioned on said base, each said pad having a suitable insulating structural layer interposed between an upper layer and an underlying moisture barrier layer, said upper layer being of a kind which allows penetrative attachment (such as by way of screwing or nailing) and/or attachment by adhesion, and
a panel or an array of panels attached as a floor surface defining sheet or array of sheets on said pads.

20. A floor structure which comprises or includes
a water permeable base,
a plurality of supporting pads positioned on said base, each said pad having a suitable plastics or closed cell foam structure layer interposed between an upper composite board layer and an underlying moisture barrier layer, and
a composite board layer attached as a floor surface defining sheet or array of sheets on said pads.

21. A structure of claim 19 or 20 wherein gaps between the floor defining surface sheets are staggered with respect to any gaps between said pads.

22. A structure of any one of claims 19 to 21 wherein any gaps between tile floor defining sheets are caulked.

23. A structure of claim 22 wherein the caulking is with construction adhesive, acrylic sealant or silicone sealant.

24. A structure of any one of claims 19 to 23 wherein said base is provided by a particulate material that is not substantially absorbent of moisture.

25. A structure of claim 24 wherein the particulate material is gravel or rock pieces substantially devoid of fines.

26. A structure of claim 25 wherein said water permeable base is of rock pieces of a particle size of primarily from 9 mm to 25 mm or of ASTM mesh of U.S. mesh ⅜ to U.S. mesh 1.

27. A structure of claim 24, 25 or 26 wherein said base is compacted so as to be load bearing.

28. A structure of any one of claims 19 to 27 wherein said base is to a depth of from 150 to 300 mm.

29. A structure of any one of claims 19 to 28 wherein said base is confined at least in part by a peripheral structure.

30. A structure of claim 29 wherein said peripheral structure is load bearing for directly or indirectly (at least in part) supporting and/or locating peripheral walls.

31. A structure of any one of claims 19 to 30 wherein said pads are of a thickness of from 50 mm to 250 mm.

32. A structure of any one of claims 19 to 31 wherein the insulating structural layer or foam structure layer of each pad is a foam layer of a thickness within the range of from 30 mm to 200 mm.

33. A structure of any one of claims 19 to 32 wherein each pad has a bottom moisture barrier layer from 0.1 mm to 3.0 mm thick.

34. A structure of claim 33 wherein said moisture barrier layer is or includes bitumen or a non porous plastics material.

35. A structure of any one of claims 19 to 34 wherein the floor surface defining panel(s) or board is a composite board of from 9 mm to 25 mm thick.

36. A structure of any one of claims 19 to 35 wherein each pad is rectangular or square of area of about 1.5 to 13.0 square metres.

37. A structure of any one of claims 19 to 36 wherein each panel or board for the floor surface is of area from about 1.5 to 15.0 square metres.

38. A structure of any one of claims 19 to 37 wherein each said pad is prefabricated by adhesive or other association of an upper composite board layer to a suitable plastics foam or closed cell foam insulating structural layer and the provision of a moisture barrier layer on the bottom of said foam.

39. A structure of claim 38 wherein said moisture barrier layer is provided by either
(i) adhesively or otherwise attaching a preformed moisture barrier sheet, (eg; of polyethylene) or
(ii) some laying up on such foam material by spraying, rolling or other appropriate process of an appropriate moisture barrier material (eg; bitumen).

40. A structure of claim 39 wherein each moisture barrier layer is an adhesively affixed layer of an appropriate sheet material to the foam.

41. A structure of claim 38, 39 or 40 wherein said upper board layer of each said pad is adhesively affixed to the foam.

42. A structure of claim 40 wherein a water permeable adhesive is used between said foam and said moisture barrier layer (eg; polychloroprene) to allow water egress from between said foam and said underlying water barrier layer.

43. A structure of any one of claims 19 to 42 wherein a said floor defining composite board layer is attached by penetrative attachment down into and/or adhesive attachment to the underlying yet upper layer of each paid which is of composite board or sheet metal.

44. A structure of any one of claims 19 to 43 wherein arrays of the floor defining composite boards are any of the arrays referred to in the aforementioned University of Oregon disclosure.

45. A method of erecting a foundation structure (eg; suitable for a building) which comprises or includes the steps of
(i) defining a load carrying periphery (optionally with additional load carrying members inwardly thereof),
(ii) prior to, during and/or after (i) compacting within said periphery a water permeable base,
(iii) overlaying said water permeable base with a plurality of pads having an insulating character, and
(iv) creating a floor with one or more panels supported (at least in part) directly or indirectly by both said load carrying periphery and the pads having an insulating structure.

46. A method of claim 45 the insulating character of the pads is to both
(i) reduce heat loss down to said water permeable base, and
(ii) reduce water uplift within the pad to the panel or panels of the floor.

47. A method of erecting a foundation structure (eg; suitable for a building) which comprises or includes the steps of
(a) defining a load carrying periphery (optionally with additional load carrying members inwardly thereof) and a water permeable base therein,
(b) overlaying said water permeable base with an insulating structure at least in part of a suitable plastics or other closed cell foam, and
(c) creating a floor with one or more panels supported (at least in part) directly or indirectly by one or both said load carrying periphery and insulating structure.

48. A method of claim 47 wherein said load carrying periphery is defined by beams at or adjacent the periphery.

49. A method of claim 48 wherein said beams are of wood.

50. A method of any one of claims 47 to 49 wherein said periphery is at least in part established by driving posts, piles or the like (hereafter “posts”) and thereafter fitting to such posts appropriate beams to define said peripheral structure together with said posts.

51. A method of claim 50 wherein said posts are cut subsequent to driving where needed.

52. A method of claim 50 or 51 wherein said posts are checked to accommodate the beam or beams.

53. A method of claim 50, 51 or 52 wherein said water permeable base is compacted within said periphery to a level established by said posts and/or said beams.

54. A method of claim 53 wherein said compacting relies on screeding and rolling or screeding and tamping, or both.

55. A method of any one of claims 47 to 54 wherein a peripheral timber plate is fitted to said periphery, such plate to define the underside level of the floor to be defined by the one or more panels to be used for step (iv).

56. A method of any one of claims 47 to 55 wherein said base is provided by a particulate material.

57. A method of claim 56 wherein said water permeable base is of rock pieces of a particle size of from 9 mm to 25 mm or of ASTM mesh of U.S. mesh ⅜ to U.S. mesh 1.

58. A method of claim 56 or 57 wherein said base is to a depth of from 150 to 300 mm.

59. A method of any one of claims 47 to 58 wherein said insulating structure includes a plastics closed cell foam.

60. A method of any one of claims 47 to 59 wherein a moisture barrier layer is provided on one and preferably both said load carrying periphery and/or said water permeable base.

61. A method of any one of claims 47 to 60 wherein a bitumen damp course or other material is provided to provide a moisture barrier layer on said load carrying periphery below fitted peripheral timber plates to underlie the floor providing panel or panels, such peripheral plates to underlie wall plates of wall structures to be erected thereon.

62. A method of any one of claims 47 to 61 wherein a moisture barrier layer is provided on and therefore is interposed between said water permeable base and said foam, said barrier forming part of an assembly of which said foam forms part.

63. A method of any one of claims 47 to 62 wherein said insulating structure comprises or includes a plurality of supporting pads each positioned on said water permeable base, each said pad having the foam layer interposed between an upper structural layer of board or metal and an underlying moisture barrier layer.

64. A method of any one of claims 47 to 63 wherein said floor creating panels are rectangular in shape save for shape adjustment of any such rectangular form required to assume a line along the perimeter.

65. A method of claim 64 wherein the major axes of each such rectangular panel is angled so as to be otherwise than orthogonal or parallel to a said periphery.

66. A method of claim 65 wherein the angling of said floor panel or panels is such as to avoid all risk of abutment of individual panels on a line above a line of abutment or substantial abutment of underlying insulating structures.

67. A method of any one of claims 64 to 66 wherein each floor creating panel is fixed using screws (optionally in addition to adhesive) to a structural layer at the top of the insulating structure.

68. A method of erecting a foundation structure (eg; suitable for a building) which comprises or includes the steps of
(i) defining a load carrying periphery (optionally with additional load carrying members inwardly thereof),
(ii) compacting within said periphery a water permeable base (whether wholly after (i) or not),
(iii) overlaying said water permeable base with an insulating structure at least in part of a suitable plastics or other closed cell foam, and
(iv) creating a floor with one or more panels supported (at least in part) directly or indirectly by one or both said load carrying periphery and insulating structure.

69. A method of erecting a foundation structure (eg; suitable for a building) which comprises or includes the steps of
(a) defining a load carrying periphery (optionally with additional load carrying members inwardly thereof) and a water permeable base therein,
(b) overlaying said water permeable base with an insulating structure at least one water permeable base supported pad, and
(c) creating a floor with one or more panels supported (at least in part) directly or indirectly by one or both said load carrying periphery and insulating structure.

70. A method of claim 69 wherein said periphery is established by driving posts, piles or the like (hereafter “posts”) and thereafter fitting to such posts appropriate beams to define said peripheral structure together with said posts.

71. A method of claim 69 or 70 wherein said insulating structure comprises a plurality of supporting pads each positioned on said water permeable base, each said pad having the foam layer interposed between an upper structural layer of board or metal and an underlying moisture barrier layer. Preferably said structural layer is one into which the floor panel or panels can be fixed at least in part by a penetrative means.

72. A method of claim 71 wherein said upper structural layer is a composite board.

73. A method of erecting a foundation structure (eg; for a building) which comprises the steps of
defining a water permeable base,
supporting a plurality of rectangular or square supporting pads on said base, each said pad having a suitable foam structural layer interposed between an upper layer and an underlying moisture barrier layer, (said upper layer being of the kind which allows (a) penetrative attachment such as by screwing or nailing and/or (b) attachment by adhesion), and
laying and attaching an array of panels on said pads, said panels being essentially rectangular or square (or truncations thereof to provide at least one oblique edge) with the array of such panels oblique to at least most of the edges of the underlying supporting pads.

74. A floor structure substantially as herein described with reference to any of the accompanying drawings.

75. A foundation or floor substantially as herein described with reference to the periphery and any one or more of FIGS. 3 onwards.

76. A method of defining a floor or foundation for a structure or building when performed substantially as herein described with reference to any one or more of the accompanying

77. A method of forming a periphery confinement thus formed suitable for use in a floor structure or a foundation structure as claimed in any one of claims 1 to 44, 74 and 75.

78. A floor and foundation periphery substantially as herein described with reference to any one or more of the accompanying drawings.

79. A floor of an array of panels supported peripherally on a structure dependent from driven piles and centrally of said driven piles by a plurality of pad like structures that are supported on a water permeable base of a particulate material on the ground.

80. A building having a floor or floor structure of any one of claims 1 to 44.
